(19) United States
(12) Patent Application Publication
(10) Pub. No.: US 2018/0222276 A1
(43) Pub. Date: Aug. 9, 2018

(54) AUTOMATIC TILTING VEHICLE

(71) Applicant: TOYOTA JIDOSHA KABUSHIKI KAISHA, Toyota-shi (JP)

(72) Inventors: Yukihide KIMURA, Gotenba-shi (JP); Toshihide YANO, Susono-shi (JP); Junrou YAMAMOTO, Susono-shi (JP); Taku NAGASAWA, Susono-shi (JP)

(21) Appl. No.: 15/889,649

(22) Filed: Feb. 6, 2018

(30) Foreign Application Priority Data
Feb. 9, 2017 (JP) 2017-022272

(51) Int. Cl. B60G 21/05; B60G 21/00

(52) U.S. Cl. CPC B60G 21/05; B60G 2400/0511; B60G 2300/45; B60G 21/005

(57) ABSTRACT

An automatic tilting vehicle is provided that includes left and right wheels supported by knuckles, a vehicle tilting device, and a control unit. The vehicle tilting device includes a swing member, an actuator for swing the swing member, and a pair of tie rods pivotally attached to the swing member and the knuckles. When a tilt angle of the vehicle is equal to or less than an allowable maximum tilt angle, a pivot point of the pivotal attachment portion at the lower end of the turning outer tie rod is located inside the vehicle with respect to a line segment connecting a grounding point of the corresponding wheel and a pivot point of the pivotal attachment portion at the upper end of the same tie rod.

### CROSS-REFERENCE TO RELATED APPLICATION

The disclosure of Japanese Patent Application NO. JP2017-22272 filed on Feb. 9, 2017 is incorporated by reference in its entirety.

### BACKGROUND

### 1. Technical Field

The present disclosure relates to an automatic tilting vehicle that automatically tilts (self inclines) to the inside of a turn when turning.

### 2. Description of the Related Art

An automatic tilting vehicle has a vehicle tilting device, and the vehicle is automatically tilted to the inner side of a turn by the vehicle tilting device at the time of turning. For example, International Publication No. 2012/049724 describes an automatic tilting vehicle that includes a pair of front wheels spaced laterally, a swing type vehicle tilting device, and a control unit that controls the vehicle tilting device, and the pair of front wheels are rotatably supported by corresponding knuckles. The vehicle tilting device includes a swing member swingable about a swing axis extending in a longitudinal direction of the vehicle, an actuator that swings the swing member about the swing axis, and a pair of tie rods. The pair of tie rods are integrally connected at the lower ends to the corresponding knuckles and pivotally connected at the upper ends to outer ends of the swing member on both lateral sides of the swing axis. Each tie rod includes a shock absorber and a suspension spring.

When the swing member swings about the swing axis, the pair of tie rods vertically move in opposite directions to each other, so that the front wheels move up and down in opposite directions relative to a vehicle body, thereby the vehicle inclines in a lateral direction. The control unit calculates a target tilt angle of the vehicle for stably turning the vehicle based on a steering operation amount of a driver and a vehicle speed and controls a swing angle of the swing member by the actuator to tilt the vehicle so that a tilt angle of the vehicle conforms to the target tilt angle. A centrifugal force acting on a center of gravity of the vehicle based on a steering operation amount of the driver and a vehicle speed is estimated, and a target tilt angle of the vehicle is calculated, for example, so that a resultant force of the estimated centrifugal force and the gravity acts in a predetermined direction, in other word, so that a ratio of the gravitational acceleration and a target lateral acceleration of the vehicle based on a steering operation amount and a vehicle speed conforms to a predetermined ratio.

In a conventional automatic tilting vehicle as described in the above International Publication, when the swinging member is swung so as to move the pair of tie rods vertically in opposite directions to each other, a shock absorber and a suspension spring in each tie rod expands/contracts. Therefore, it is difficult to precisely control a tilt angle of the vehicle with good response so that the tilt angle of the vehicle conforms to a target tilt angle. Furthermore, each tie rod is integrally connected to a corresponding knuckle at the lower end, it cannot pivot relative to the knuckle. Therefore, a range of the vertical movement of each tie rod is limited to a narrow range and, accordingly, an angular range capable of tilting the vehicle is limited.

In order to solve the aforementioned drawbacks of the conventional automatic tilting vehicle, a configuration has already been known in which each tie rod is pivotally connected at the lower end to a corresponding knuckle and is pivotally connected at the upper end to the outer end of the swing member, and a shock absorber and a suspension spring are disposed between the actuator and the vehicle body. In the automatic tilting vehicle of this configuration (hereinafter referred to as “improved automatic tilting vehicle”), left and right front wheels are suspended from a vehicle body by front wheel suspensions so that they can relatively displace with respect to the vehicle body in the vertical direction of the vehicle, but a relative inclination in the lateral direction with respect to the vehicle body is restricted.

According to an improved automatic tilting vehicle, since the tie rods that include no shock absorber and no suspension spring can transmit the displacement of the swing member to the knuckles efficiently and without delay, it is possible to accurately control the tilt angle of the vehicle to a target tilt angle with good responsiveness. Further, since each tie rod can pivot relative to both of the swing member and the knuckle, the turning performance of the vehicle can be improved by enlarging a range in which the tie rods can move vertically and enlarging an angular range in which the vehicle can tilt.

### SUMMARY

When the improved automatic tilting vehicle is tilted to the inside of a turn when turning, the left and right front wheels are inclined together with the vehicle body in a state of being rotated. A gyro moment acts to return the position of each of the left and right front wheels to the position in a standard state as in a straight running of the vehicle and a force caused by each gyro moment acts through the tie rod, the swing member, and the actuator, and is transmitted to the vehicle body via the front wheel suspension. Therefore, the vehicle body receives a force toward the outside of a turn, and the force acts to reduce a tilt angle of the vehicle. Therefore, the actuator must not only swing the swing member so that a tilt angle of the vehicle becomes a target tilt angle, but also generate a force for maintaining the tilt angle of the vehicle at the target tilt angle against the above-mentioned action by the gyro moments. Accordingly, it is inevitable that an energy consumed by the actuator increases as compared to where no gyro moment acts on the left and right front wheels.

Further, as will be described in detail later, a relationship between the positional relationship between the swing member and the pair of tie rods becomes different from that in the standard state of the vehicle, and the actuator is displaced downward with respect to the wheels, resulting in that a height of the vehicle body becomes lower than the original height. When the height of the vehicle body is lowered, a center of gravity of the vehicle is displaced downward along the inclination direction of the vehicle, and a turning radius of the center of gravity increases in comparison with that in the standard state of the vehicle, so that an actual lateral acceleration of the vehicle decreases. Therefore, since a deviation between a target lateral acceleration and the actual lateral acceleration of the vehicle becomes large, even if the vehicle tilting device is controlled so that the tilt angle of the vehicle becomes a target tilt angle, the tilt angle of the vehicle cannot accurately be controlled to the target tilt angle.

Further, when the positional relationship between the swing member and the pair of tie rods changes, elastic deformation amounts of elastic members elastically urging the swing member and the pair of tie rods to their positions in the standard state of the vehicle change from the original values which accumulates energy. The elastic members in this case are, for example, rubber bushes incorporated in the pivotal attachment portions.

In particular, when the vehicle is decelerated at a very high deceleration while the vehicle is turning, gyro moments abruptly decrease and forces transmitted to the swing member via the tie rods decrease sharply. Therefore, the energy accumulated in each elastic member is released, the vehicle body is suddenly displaced upward with respect to the actuator along the inclination direction of the vehicle, and the center of gravity of the vehicle rapidly rises. Since the elastic deformation amount of each elastic member increases and decreases oscillatingly, a height of the center of gravity of the vehicle vibrates and a actual lateral acceleration of the vehicle also vibrates. Therefore, even if the vehicle tilting device is controlled so that the tilt angle of the vehicle becomes a target tilt angle, the tilt angle of the vehicle vibrates and the tilt angle of the vehicle cannot be accurately controlled to the target tilt angle.

The present disclosure provides an automatic tilting vehicle improved to reduce an energy consumption by an actuator as compared with the prior art by reducing an influence of the gyro moments acting on a pair of wheels on a tilt angle of the vehicle when the automatic tilting vehicle turns, thereby improving the controllability of a tilt angle of the vehicle.

According to the present disclosure, an automatic tilting vehicle is provided which includes a pair of laterally spaced wheels, a vehicle tilting device, and a control unit; each wheel is rotatably supported by a corresponding knuckle; the vehicle tilting device includes a swing member swinging around a swing axis extending in the longitudinal direction of the vehicle, an actuator for swinging the swing member around the swing axis, and a pair of tie rods pivotally attached to the swing member at upper end pivotal attachment portions on both lateral sides of the swing axis and pivotally attached to the corresponding knuckles at lower end pivotal attachment portions; the control unit is configured to calculate a target tilt angle of the vehicle so as not to exceed a preset allowable maximum tilt angle at the time of turning of the vehicle and to tilt the vehicle to the inner side of a turn by controlling the actuator so that the tilt angle of the vehicle conforms to the target tilt angle.

The actuator is connected to the vehicle body via a suspension spring so as to be vertically displaceable with respect to the vehicle body and to limit the lateral displacement and inclination with respect to the vehicle body. The pair of wheels, the actuator, the swinging member and the pair of tie rods are resiliently biased to the positions that they take when the vehicle runs straight. The vehicle tilting device is arranged such that, when the tilt angle of the vehicle is equal to or less than the allowable maximum tilt angle, as viewed in the longitudinal direction of the vehicle, a pivot point of the pivotal attachment portion at the lower end of the tie rod on the outer side of a turn is located on the inside of the vehicle with respect to a line segment connecting a grounding point of the corresponding wheel and a pivot point of the pivotal attachment portion of the upper end of the tie rod.

As will be described in detail later, when the automatic tilting vehicle is tilted to the inner side of a turn by the vehicle tilting device at the time of turning, gyro moments act on the pair of wheels so as to return their positions to the positions in a standard state as in straight running of the vehicle. Therefore, since the pair of wheels attempts to pivot around their grounding points in the direction of decreasing the inclination of the wheels, the pivotal attachment portion at the lower end of the turning outer tie rod attempts to pivot outwardly about the grounding point of the corresponding wheel.

According to the above configuration, the center of the pivotal attachment portion at the lower end of the tie rod on the outer side of a turn is located inside the vehicle with respect to a line segment connecting the grounding point of the corresponding wheel and the center of the pivotal attachment portion at the upper end of the same tie rod. Therefore, the pivotal attachment portion at the lower end of the turning outer tie rod attempts to pivot around the grounding point of the corresponding wheel to the outside of the turn, so that the distance between the grounding point of the wheel and the pivot center of the upper end of the tie rod is increased and the distance between the grounding point of the wheel and the actuator is increased. As a result, since the tilt angle of the vehicle is increased, the amount by which the tilt angle of the vehicle is reduced by forces generated by gyro moments can be reduced as compared with the prior art. Therefore, it is possible to reduce a force that the actuator must generate to control and maintain the tilt angle of the vehicle at a target tilt angle, so that an energy consumption by the actuator can be reduced as compared with the prior art.

In addition, the pivotal attachment portion at the lower end of the turning outer tie rod attempts to pivot outwardly about the grounding point of the corresponding wheel, which increase the distance between the grounding point of the wheel and the pivot center of the upper end of the tie rod. As a result, a height of the pivotal attachment portion at the upper end increases, and a downward displacement amount of the actuator with respect to the wheel at the time of turning of the vehicle decreases. Therefore, it is possible to reduce an amount of displacement of the center of gravity of the vehicle downward along the inclination direction of the vehicle, and to reduce an amount by which the turning radius of the center of gravity increases compared with a turning radius in the standard state of the vehicle. Therefore, it is possible to reduce a decrease amount of an actual lateral acceleration of the vehicle and reduce the deviation between a target lateral acceleration and an actual lateral acceleration of the vehicle, so that the tilt angle of the vehicle can accurately be controlled to a target tilt angle.

In addition, when the pivotal attachment portion of the lower end of the turning outer tie rod pivots outwardly about the grounding point of the corresponding wheel, the upper pivotal attachment portion is moved upwardly and to the inner side of turning. Consequently, it is possible to reduce an amount by which the upper pivotal attachment portion is moved downward and outward in a turn by the action of gyro moments as compared with the prior art. Therefore, a degree in which the positional relationship between the swing member and the pair of tie rods becomes different from that in the standard state of the vehicle is reduced, and an amount of elastic deformation of each elastic member is reduced, so that the energy accumulated in the elastic members can be reduced as compared with the prior art.

Accordingly, even if the vehicle decelerates at a very high deceleration and the gyro moments abruptly decrease, an amount by which the energy stored in the elastic members is released is smaller than in the prior art, so that it is possible to reduce an amount by which the elastic deformation amount of each elastic member increases and decreases oscillatingly. Therefore, since an amount by which an actual lateral acceleration of the vehicle vibrates due to the vibration of the height of the center of gravity of the vehicle can be reduced, it is possible to reduce a vibration of the tilt angle of the vehicle and accurately control the tilt angle of the vehicle to a target tilt angle, and it is possible to improve the controllability of the tilt angle of the vehicle as compared with the prior art.

In one aspect of the present disclosure, the vehicle tilting device includes a pair of knuckle arms extending at least in the upward direction with respect to the respective knuckles and vertically moving integrally with the corresponding knuckles, and each tie rod is pivotally attached to the upper end of the corresponding knuckle arm at the lower end pivotal attachment portion.

According to the above aspect, a height of the pivotal attachment portion at the lower end of each tie rod can be made higher as compared to where the vehicle tilting device does not include a pair of knuckle arms so that forces for increasing the distances between the grounding points of the wheels and the actuator can be increased. Therefore, in a situation where gyro moments act on the pair of wheels at the time of turning of the vehicle, a force for moving the pivotal attachment portion at the upper end of the tie rod on the outer side of a turn downward and toward the outside of the turn, that is, a force for reducing the tilt angle of the vehicle can be reduced. Therefore, it is possible to effectively reduce a force that the actuator must generate to control and maintain the tilt angle of the vehicle at a target tilt angle, and effectively reduce a energy consumption by the actuator as compared with a conventional automatic tilting vehicle.

According to the above aspect, the effect of increasing the distances between the grounding points of the wheels and the actuator can be increased as compared to where the vehicle tilting device does not include a pair of knuckle arms as described above. Therefore, an amount by which the center of gravity of the vehicle is displaced downward along the inclination direction of the vehicle by the action of gyro moments is effectively reduced, and an amount by which a turning radius of the center of gravity increases compared with a turning radius in the standard state of the vehicle can be reduced. Therefore, it is possible to effectively reduce a decrease amount in an actual lateral acceleration of the vehicle and effectively reduce a deviation between a target lateral acceleration and an actual lateral acceleration of the vehicle, so that the controllability of the tilt angle of the vehicle can effectively be enhanced as compared to where the vehicle tilting device does not include a pair of knuckle arms.

Further, according to the above aspect, an amount by which the upper end pivotal attachment portion is moved upward and to the inner side of a turn becomes larger as compared to where the vehicle tilting device does not include a pair of knuckle arms, so that an amount by which the upper pivotal attachment portion is moved downward and toward the outside of a turn due to the action of gyro moments is effectively reduced. Therefore, it is possible to effectively reduce an amount of elastic deformation of the elastic members due to the positional relationship between the swing member and the pair of tie rods becoming different from that in the standard state of the vehicle, and an amount of the energy stored in the elastic members can effectively be reduced. Accordingly, it is possible to effectively reduce an amount of elastic deformation of the elastic members that vibratingly increases and decreases when the vehicle is decelerated at a very high deceleration and the gyro moments abruptly decrease and to effectively reduce a vibration of the tilt angle of the vehicle, which also effectively improves the controllability of the tilt angle of the vehicle.

In another aspect of the present disclosure, a camber of the pair of wheels is a negative camber.

As a center of the pivotal attachment portion at the lower end of the tie rod with respect to a rotation center plane of each wheel is on the inner side of the vehicle, the center of the pivotal attachment portion at the lower end of the turning outer tie rod can be easily positioned inside the vehicle with respect to a line segment connecting a grounding point of the wheel and a center of the pivotal attachment portion at the upper end of the tie rod. However, as the center of the pivotal attachment portion at the lower end of the tie rod with respect to a wheel rotation center plane is on the inner side of the vehicle, a distance between the rotation center plane and the center of the pivotal attachment portion at the lower end of the tie rod becomes larger and a efficiency of the swing member moving the wheel vertically with respect to the vehicle body via the tie rod at the time of turning of the vehicle decreases.

According to the above aspect, since a camber of the pair of wheels is a negative camber, the distance between the rotation center plane of the wheel and the center of the pivotal attachment portion of the lower end of the tie rod can be reduced as compared to where the camber of the wheel is a neutral camber or a positive camber. Therefore, while avoiding an excessive decrease in the above-mentioned efficiency and an excessive reduction of the efficiency, the center of the pivotal attachment portion at the lower end of the tie rod on the turning outer side can be easily positioned inside the vehicle with respect to a line segment connecting the grounding point of the wheel and the center of the pivotal attachment portion of the upper end of the tie rod.

In another aspect of the present disclosure, the pair of tie rods are configured not to be substantially curvingly deformed even if compressive loads vary due to the operation of the vehicle tilting device.

As will be described in detail later, as the tie rods support the weight of the vehicle body, they always receives a compressive load. When the automatic tilting vehicle is tilted by the action of the vehicle tilting device at the time of turning, the pivotal attachment portion at the upper end of each tie rod receives a vertical force from the pivoting member and the pivotal attachment portion at the lower end of each tie rod receives a vertical force due to the gyro moment. Since these forces are changed by the variation of the tilt angle of the vehicle due to the operation of the vehicle tilting device, the compressive load of each tie rod varies with the operation of the vehicle tilting device.

According to the above aspect, the pair of tie rods are configured not to be substantially curvingly deformed even if compressive loads vary due to the operation of the vehicle tilting device. Therefore, it is possible to substantially prevent the actuator from being displaced downward with respect to the vehicle body that is caused when the tie rod on the turning outer wheel side is curvingly deformed by the action of a compressive load when the vehicle turns, and a distance between the upper end pivotal attachment portion and the lower end pivotal attachment portion accordingly decreases. Furthermore, the effect of pivoting the pivotal attachment portion at the lower end of the tie rod on the turning outer wheel side to the outside of a turn around a grounding point of the corresponding front wheel displaces upward the pivotal attachment portion at the upper end of the tie rod can be substantially prevented from being reduced by the curved deformation of the tie rod.

The expression “not substantially curvingly deformed” means that a reduction rate of the distance between the pivotal attachment portions of the upper and lower ends of the tie rod is 3% or less, preferably 2% or less, more preferably 1%.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is an schematic front vertical cross-sectional view showing an embodiment of an automatic tilting vehicle according to the present disclosure.

FIG. 2 is a skeleton diagram showing the front wheels and the vehicle tilting device of the embodiment in a state viewed from the front of the vehicle.

FIG. 3 is a schematic lateral vertical cross-sectional view showing the automatic tilting vehicle of the embodiment taken along the center vertical cut plane in the front-rear direction.

FIG. 4 is a plan sectional view of the automatic tilting vehicle of the embodiment, taken along a horizontal section.

FIG. 5 is an enlarged perspective view showing a rear wheel and a rear wheel suspension according to the embodiment.

FIG. 6 is a front vertical cross-sectional view showing the embodiment in a state of left turning cut along the lateral vertical cutting plane at the front wheel position.

FIG. 7 is a flowchart showing a vehicle tilt angle control routine according to the embodiment.

FIG. 8 is a front vertical cross-sectional view showing a situation in which a perpendicular passing through a center of gravity of the vehicle turning left passes through outside a range of a triangle formed by connecting the grounding points of the left and right front wheels and the grounding point of the rear wheels.

FIG. 9 is a front vertical sectional view showing a situation in which a tilt angle of the vehicle is decreasingly corrected such that a perpendicular passing through a center of gravity of the vehicle turning left passes through a range of a triangle formed by connecting the grounding points of the left and right front wheels and the grounding point of the rear wheel.

FIG. 10 is a skeleton diagram showing the front wheels and the vehicle tilting device of the embodiment when the tilt angle of the vehicle turning left is an allowable maximum tilt angle, as seen from the front of the vehicle.

FIG. 11 is a skeleton diagram showing the front wheels and the vehicle tilting device of a conventional improved automatic tilting vehicle when a tilt angle of the vehicle turning to the left is an allowable maximum tilt angle as seen from the front of the vehicle.

FIG. 12 is a skeleton diagram showing the front wheels and the vehicle tilting device of a modified example as seen from the front of the vehicle.

FIG. 13 is a skeleton diagram showing the front wheels and the vehicle tilting device of a modified example when a tilt angle of the vehicle that is turning to the left is an allowable maximum tilt angle, as seen from the front of the vehicle.

FIG. 14 is a map for calculating the target lateral acceleration Gyt of the vehicle based on the steering angle St and the vehicle speed V.

FIG. 15 is a schematic lateral vertical cross-sectional view showing a modified example of the automatic tilting vehicle cut along the center vertical cut plane in the front-rear direction.

### DETAILED DESCRIPTION

An embodiment of the present disclosure will now be described in detail with reference to the accompanying drawings.

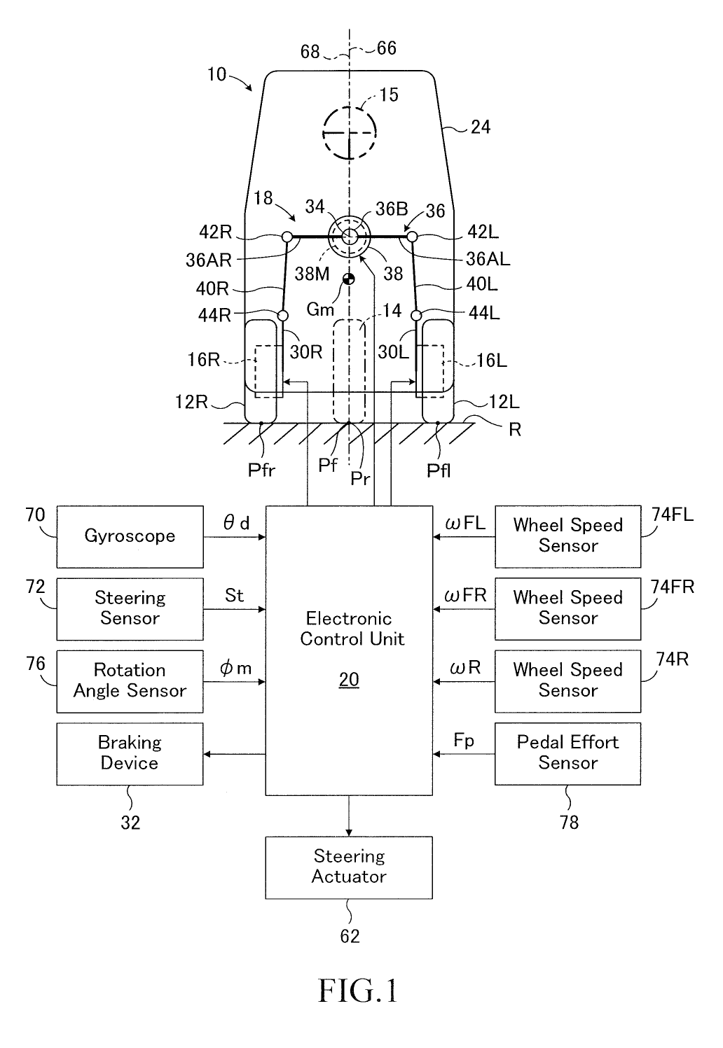

In FIGS. 1 to 4, an automatic tilting vehicle 10 according to an embodiment of the present disclosure is a tricycle vehicle with a capacity of one which includes a pair of front wheels 12L and 12R that are non-steered drive wheels, and a rear wheel 14 that is a steered driven wheel. The front wheels 12L and 12R are spaced apart from each other in the lateral direction and are rotatably supported about a rotation axis (not shown) by corresponding knuckles (wheel carriers) 16L and 16R.

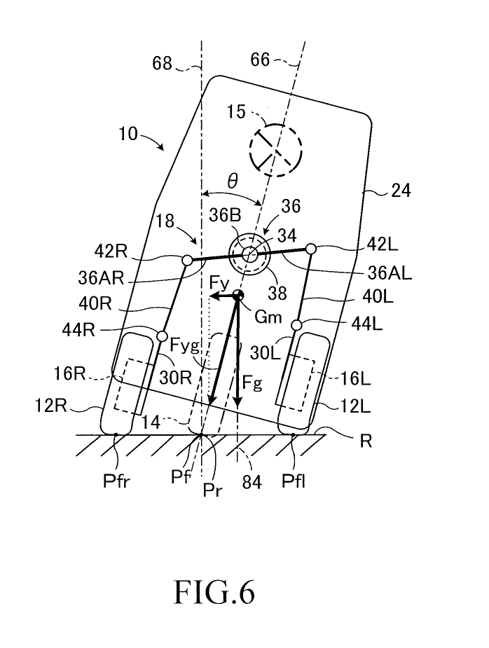

In the embodiment, a camber of the front wheels 12L and 12R is a neutral camber, so that a camber angle of the front wheels at the time when the vehicle 10 is not turning. It should be noted that the camber of the front wheels may be a negative camber as in a modified example to be described later, or may be a positive camber. The rear wheel 14 is located rearwardly of the front wheels and steered in a steer-by-wire manner according to an amount of operation of a steering wheel 15 by a driver, as will be described in detail later. In FIG. 1 and FIG. 6 described below, the steering wheel 15 is shown at a position different from an actual position. The automatic tilting vehicle 10 further includes a vehicle tilting device 18 and an electronic control unit 20.

In the illustrated embodiment, the knuckles 16L and 16R each incorporate an in-wheel motor as a driving device, which is not shown in the figure. The knuckles 16L and 16R are supported by corresponding suspension arms 22L and 22R so as to be vertically displaceable with respect to a vehicle body 24 and to restrict lateral displacement and inclination with respect to the vehicle body 24.

The illustrated suspension arms 22L and 22R are leading arms that are integrally connected to the knuckles 16L and 16R at their front ends, respectively, and are connected at their rear ends to the vehicle body 24 by joints 28L and 28R, respectively. The joints 28L and 28R may be joints such as rubber bushing devices having axes extending substantially in the lateral direction. As long as the above requirements relating to the knuckles 16L and 16R are satisfied, the suspension arms 22L and 22R may be other arms such as a trailing arm or a combination of upper and lower arms.

The lower ends of the knuckle arms 30L and 30R are integrally connected to the vicinities of the front ends of the suspension arms 22L and 22R, respectively. The knuckle arms 30L and 30R extend substantially in the upward direction from the suspension arms 22L and 22R so as to extend in the vertical direction with respect to the knuckles 16L and 16R and move up and down integrally with the front end portion of the corresponding suspension arms and the knuckles.

As shown in FIG. 1 and FIG. 6, the knuckle arms 30 L and 30 R are linear as viewed in the longitudinal direction, but as shown in FIG. 3, they are substantially C-shaped opened forward as seen in the lateral direction so that they do not interfere with members of the knuckles 16L and 16R. The knuckle arms 30L and 30R may be integrally connected to the knuckles 16L and 16R, respectively, and may be substantially C-shaped opened rearward or linear when viewed in the lateral direction.

A rotational direction and an output of each in-wheel motor are controlled by the electronic control unit 20 according to an operation amount of the shift lever and an accelerator pedal (neither shown) by the driver. Braking forces of the front wheels 12L and 12R and the rear wheel 14 are controlled by the electronic control unit 20 controlling a braking device 32 which operates according to an operation amount of a brake pedal (not shown) by the driver.

The vehicle tilting device 18 includes a swing member 36 swinging about a swing axis 34 extending in the longitudinal direction of the vehicle, a tilt actuator 38 for swinging the swing member 36 about the swing axis 34 and a pair of tie rods 40L and 40R. The tie rods 40L and 40R extend substantially in the vertical direction on both lateral sides of the swing axis 34 and are pivotally connected at their upper ends to the corresponding outer ends of the swing member 36 by joints 42L and 42R. It is preferable that the joints 42L and 42R are joints each including a pivot pin with a rubber bush having an axis extending substantially in the vehicle longitudinal direction, but they may be joints such as ball joints.

Further, the tie rods 40L and 40R are pivotally connected at the lower ends to the upper ends of the knuckle arms 30L and 30R by joints 44L and 44R such as ball joints, respectively. As described above, the knuckle arms 30L and 30R extend substantially upward from the suspension arms 22L and 22R, respectively, so as to extend in the vertical direction with respect to the knuckles 16L and 16R, and move integrally with the corresponding knuckles. Therefore, the lower ends of the tie rods 40L, 40R are integrally connected to the knuckles 16L, 16R via the knuckle arms 30L, 30R and the suspension arms 22L, 22R, respectively.

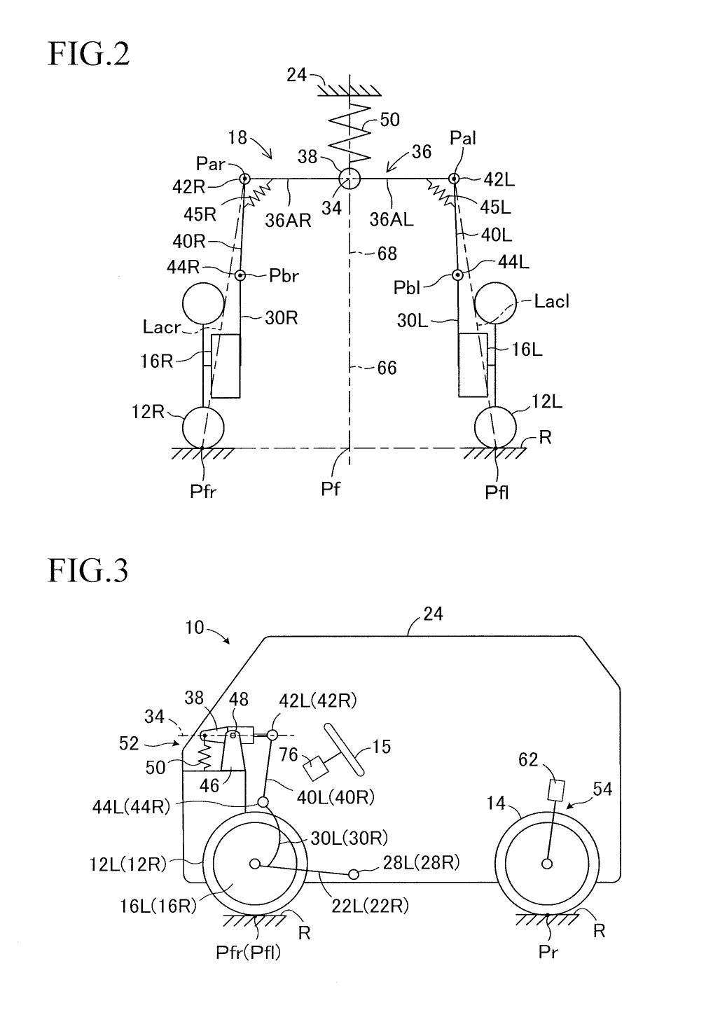

As shown in FIG. 2, centers of the joints 42L and 42R are referred to as pivot points Pal and Par, respectively, centers of the joints 44L and 44R are referred to as pivot points Pbl and Pbr, respectively, and the grounding points of the front wheels 12L and 12R are referred to as the grounding points Pfl and Pfr, respectively. The pivot points Pbl and Pbr are located higher than the upper peripheral portions of tires of the front wheels 12L and 12R, respectively when the vehicle 10 is in a standard state where the vehicle 10 is stationary or running straight on a horizontal road, but they may be located at a position equal to or lower than the upper peripheral portions of the tires.

When the vehicle 10 is in the standard state, the pivot points Pal and Par, the pivot points Pbl and Pbr, and the grounding points Pfl and Pfr, respectively are symmetrical with respect to a center plane 66 of the vehicle 10. A distance between the pivot points Pbl and Pbr is greater than a distance between the pivot points Pal and Par and less than the distance between the grounding points Pfl and Pfr. The pivot point Pbl is located inside the vehicle with respect to a line segment Lacl connecting the pivot point Pal and the grounding point Pfl, and the pivot point Pbr is located inside the vehicle with respect to a line segment Lacr connecting the pivot point Par and the grounding point Pfr.

The swing member 36 has a boss portion 36B rotatable about the swing axis 34 and arm portions 36AL and 36AR integrally formed with the boss portion 36B and extending in opposite directions from the boss portion 36B, and functions as a swing arm member that can swing about the swing axis 34. The effective lengths of the arm portions 36AL and 36AR, that is, the distance between the axis 34 and the pivot point Pbl and the distance between the axis 34 and the pivot point Pbr are the same.

As can be understood from the above descriptions, the left and right front wheels 12L and 12R, the tilt actuator 38, the swing member 36, and the pair of tie rods 40L and 40R are resiliently biased to their positions at which they take during the straight running of the vehicle. An urging means for resiliently urging the above members is made up of elasticity of the suspension arms 22L and 22R, rubber bush devices incorporated in the joints 28L and 28R at the rear ends of the suspension arms, rubber bushings incorporated in the joints 42L and 42R and so on.

In FIG. 2 and FIGS. 10 to 13, these biasing means are collectively shown as virtual elastic members 45L and 45R. The elastic members 45L and 45R may be considered to generate forces for suppressing the changes where the angles formed by the arm portions 36AL and 36AR and the tie rods 40L and 40R change from the angles in the standard state. That is, when the angle formed by the corresponding arm portion and the tie rod becomes smaller than the angle in the standard state, each elastic member generates a compressive force so as to increase the angle. Conversely, when the angle formed by the corresponding arm portion and tie rod becomes larger than the angle in the standard state, each elastic member generates a tensile force to reduce the angle.

The tilt actuator 38 may be a rotary actuator such as an electric motor 38M such as a DC brushless motor and a harmonic drive (registered trade mark) including a reduction gear not shown in the figure. The output rotary shaft of the actuator 38 protrudes rearward and the boss portion 36B is fixedly attached to the tip of the output rotary shaft so that the rotary motion of the electric motor 38M is transmitted as a swing motion to the swing member 36. The actuator 38 may be a reciprocating type or a swing type actuator. In the former case, a reciprocating motion of the actuator is converted into a swing motion by a motion converting mechanism and is transmitted to the swing member 36.

As shown in FIG. 3, the actuator 38 is arranged between a pair of brackets 46 laterally spaced and fixed to the vehicle body 24. The actuator 38 has a pair of pivot shafts 48 protruding laterally away from each other and is pivotably supported about the pivot shafts 48 as the shafts 48 are rotatably supported by the brackets 46. A suspension spring 50 and a shock absorber (not shown) are interposed between the front end portion of the actuator 38 and the vehicle body 24 below the front end portion. Therefore, the actuator 38 is connected to the vehicle body via the suspension spring 50 so that the actuator 38 can be displaced in the vertical direction with respect to the vehicle body 24 and the displacement and inclination in the lateral direction with respect to the vehicle body are restricted. It should be noted that the suspension spring 50 may be an elastic member such as a compression coil spring.

The suspension spring 50 and the shock absorber cooperate with the suspension arms 22L and 22R and the like to constitute a front wheel suspension 52. Therefore, the front wheels 12L, 12R and the vehicle tilting device 18 are suspended from the vehicle body 24 by the front wheel suspension 52. The front wheels 12 L and 12R and the vehicle tilting device 18 can move upward and downward with respect to the vehicle body 24, and the impact that the front wheels 12L and 12R are transmitted from a road surface to the vehicle body 24 during traveling of the vehicle is alleviated by the suspension spring 50. The relative vertical vibration between the front wheels 12L and 12R and the vehicle body 24 is attenuated by the shock absorber.

The actuator 38 receives a downward force via the pair of brackets 46 due to gravity acting on the vehicle body 24. However, since the actuator 38 is prevented from being displaced downward by the vehicle tilting device 18, the actuator swings about the pivot shafts 48 so that the rear portion is displaced upward with respect to the vehicle body 24 and the front portion is displaced downward with respect to the vehicle body 24. Therefore, since the suspension spring 50 is compressively deformed, a weight of the vehicle body 24 is supported by a spring force by compression deformation of the suspension spring 50. An amount of compressive deformation of the suspension spring 50 increases when the front wheels 12L and 12R bounce and the rear portion of the actuator 38 is displaced upward, and conversely decreases when the front wheel rebounds and the rear portion of the actuator 38 is displaced downward.

As shown in FIG. 5, the rear wheel 14 includes a wheel 14H and a tire 14T attached to the outer periphery of the wheel, and is suspended from the vehicle body 24 by a rear wheel suspension 54. The rear wheel suspension 54 includes an upper arm member 56 positioned above the rear wheel 14 and a pair of swing arms 58 positioned on both lateral sides of the rear wheel 14. The upper arm member 56 has a base portion 56B and a pair of upper arm portions 56A extending rearward and downward from the base portion on both sides of the rear wheel 14. Each swing arm 58 is pivotably connected to the lower end portion of the corresponding upper arm member 56A at the rear end so as to be vertically pivotable, and rotatably supports a rotation shaft 14S of the rear wheel 14 at the front end. A suspension spring 60 and a shock absorber (not shown) are interposed between a support member 14B that rotatably supports the wheel 14H and the base portion 56B. Therefore, the rear wheel 14 can move up and down with respect to the vehicle body 24, and the relative vertical vibration thereof is attenuated by the shock absorber.

A steering actuator 62 is fixed to the vehicle body 24. The steering actuator 62 is a rotary type actuator and includes an electric motor (not shown) such as a DC brushless motor. A rotating shaft of the electric motor extends downward and the tip of the rotating shaft is integrally connected to the base portion 56B of the upper arm member 56 so that the rotational motion of the electric motor is transmitted to the upper arm member 56. The steering actuator 62 may also be a reciprocating type actuator. In that case, the reciprocating motion of the actuator may be converted into a rotational motion by a motion converting mechanism and may be transmitted to the upper arm member 56.

As can be understood from the above descriptions, the rear wheel 14 is suspended from the vehicle body 24 by the rear wheel suspension 54 so as to be able to move up and down with respect to the vehicle body 24 and to be rotatable about a king pin axis 64 which is the same as the axis of the rotation axis of the electric motor of the steering actuator 62. When the vehicle 10 turns, the rear wheel 14 is steered by being rotated about the kingpin shaft 64 by the actuator 62. Since the king pin axis 64 cannot be inclined in the lateral direction with respect to the vehicle body 24, when the vehicle body 24 is tilted in the lateral direction as described later, the rear wheel 14 also inclines in the same lateral direction by the same angle as the vehicle body 24.

As shown in FIG. 6, when the swing member 36 swings about the swing axis 34, the tie rods 40L and 40R vertically move in opposite directions, so that the front wheels 12L and 12R move up and down in opposite directions with respect to the vehicle body 24, whereby the vehicle 10 is inclined in the lateral direction. In FIG. 6, the elastic deformation of the tire due to the action of the centrifugal force acting on the vehicle 10 is shown in an exaggerated manner. Although not shown in FIG. 6, as the tilt angle θ of the vehicle 10 increases, the pivot point Pbr on the turning outer wheel side moves toward the outside in the lateral direction of the vehicle with respect to the line segment Lacr, and conversely, the pivot point Pbl on the turning inner wheel side moves toward the inside in the lateral direction of the vehicle with respect to the line segment Lacl (see FIG. 2).

The knuckle arms 30L and 30R and the tie rods 40L and 40R, when they receive compressive loads for supporting the vehicle body 24 and the vehicle tilting device 18 is operated, the compressive loads increase on the turning outer wheel side and decrease on the turning inner wheel side. The knuckle arms 30L and 30R and the tie rods 40L and 40R are configured so as not to be substantially curved and deformed even if the compressive loads vary due to the operation of the vehicle tilting device 18. That is, the knuckle arms and the tie rods are configured so that even if the compressive loads fluctuate due to the operation of the vehicle tilting device 18, a reduction rate of the distance between the pivot points Pal and Par at the upper end and the pivot points Pbl and Pbr at the lower end is 3% or less, preferably 2% or less, more preferably 1% or less.

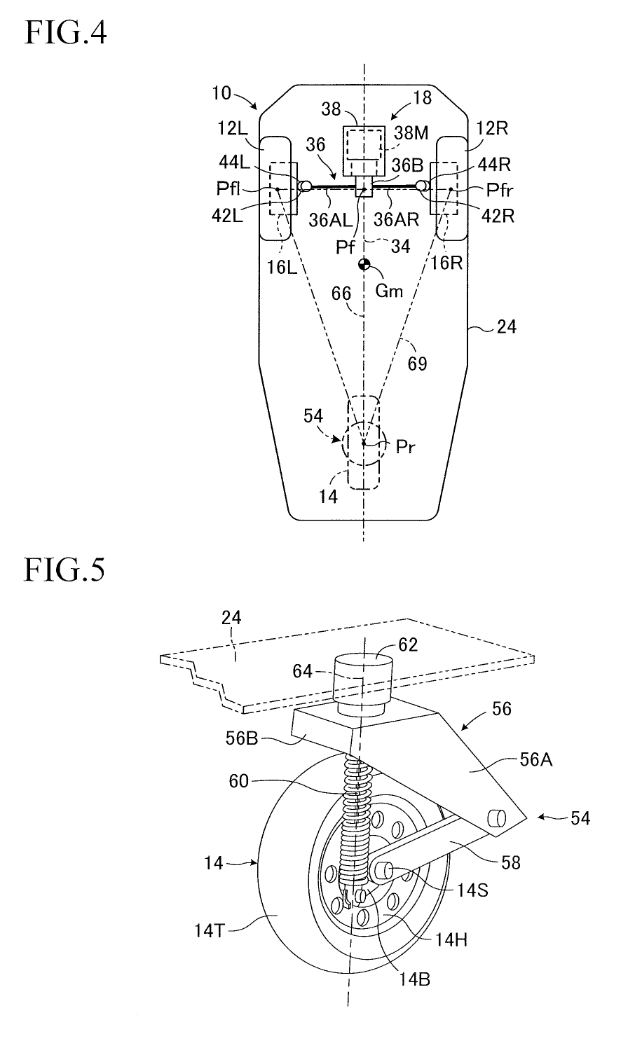

As shown in FIGS. 4 and 6, a center of gravity Gm of the vehicle 10 in the standard loading state is located behind and lower than the actuator 38 on a vertical center plane 66 of the vehicle. The tilt angle θ of the vehicle 10 is an angle that the center plane 66 forms with respect to the vertical direction 68. As shown in FIG. 4, an isosceles triangle formed by connecting the grounding points Pfl, Pfr of the front wheels 12L, 12R and the grounding point Pr of the rear wheel 14 is referred to as a triangle 69.

A change rate of the tilt angle θ of the vehicle 10, that is, a tilt angular velocity θd of the vehicle, is detected by the gyroscope 70. A signal indicating the tilt angular velocity θd of the vehicle detected by a gyroscope 70 is input to the electronic control unit 20. The tilt angle θ becomes 0 when the swing angle of the swing member 36 is 0 and the center plane 66 coincides with the vertical direction 68, and becomes a positive value when the vehicle 10 is inclined to the left. The tilt angular velocity θd is a positive value when the tilt angle of the vehicle 10 changes to the left. Furthermore, since the tilt angle 9 of the vehicle 10 is substantially the same as a roll angle (not shown) of the vehicle body 24, a roll angle of the vehicle body may be detected as a tilt angle θ of the vehicle 10 by a roll angle sensor.

A steering angle St equal to a rotation angle of the steering wheel 15 is detected by a steering angle sensor 72. Further, signals indicating wheel speeds ωFL, ωFR and ωR of the left and right front wheels 12 L, 12R and the rear wheels 14 detected by wheel speed sensors 74FL, 74FR and 74R are input to the electronic control unit 20 and a signal indicating a rotation angle φm of the electric motor 38M detected by a rotation angle sensor 76 is input to the electronic control unit 20. The electronic control unit 20 calculates a vehicle speed V based on the wheel speeds ωFL, ωFR and ωR and controls the rotation angle of the electric motor of the steering actuator 62 of the rear wheel 14 based on the steering angle St and the vehicle speed V so as to steer the rear wheel 14 in a steer-by-wire manner. The rotation angle φm becomes 0 when the swing angle of the swing member 36 is 0 and becomes a positive value when the swing member 36 swings so that the vehicle 10 tilts to the left.

Although not shown in the figures, a signal indicating an accelerator position Ap which is a depression operation amount of an accelerator pedal operated by the driver is input from an accelerator position sensor to the electronic control unit 20. To the electronic control unit 20, a signal indicating a shift position Sp, which is an operation position of a shift lever operated by the driver, is input from a shift position sensor. Further, to the electronic control unit 20, a signal indicating a pedaling force Fp to a brake pedal (not shown) by the driver is input from a pedal effort sensor 78. The electronic control unit 20 controls the driving force of the front wheels 12L and 12R by controlling the output and rotation direction of the in-wheel motors based on the accelerator position Ap and the shift position Sp. Further, the electronic control unit 20 controls the braking device 32 based on the pedal effort Fp, thereby controlling the braking forces of the front wheels 12L, 12R and the rear wheel 14. During braking, regeneration by in-wheel motors may be performed.

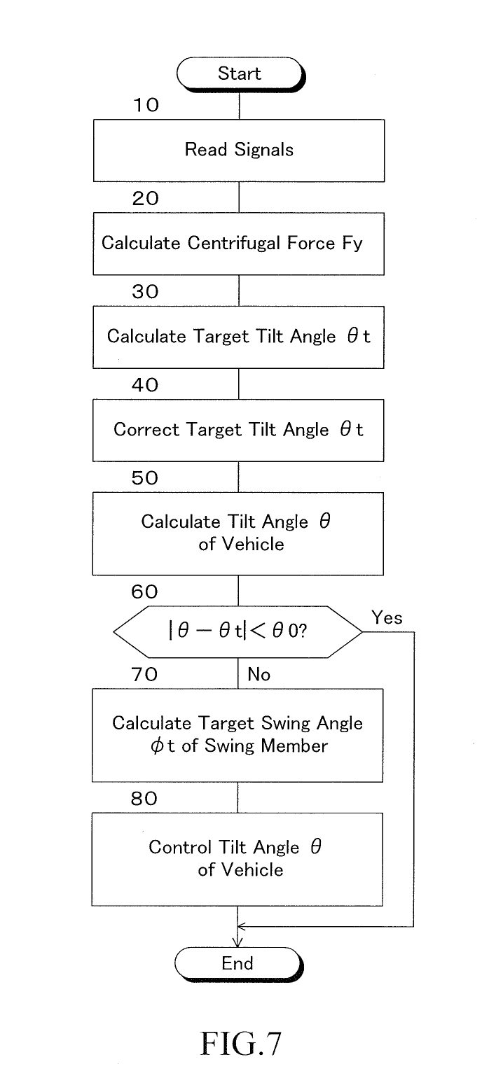

The electronic control unit 20 calculates, according to the flowchart shown in FIG. 7, a target tilt angle θt of the vehicle 10 for tilting the vehicle 10 toward the inside of a turn so that a resultant force Fyg of a centrifugal force Fy acting on the center of gravity Gm of the vehicle 10 and a gravity Fg acts in a predetermined direction. Further, the electronic control unit 20 controls the rotation angle φm of the electric motor 38M of the actuator 38 so that the tilt angle θ of the vehicle becomes the target tilt angle θt. Therefore, the electronic control unit 20 functions as a control unit configured to tilt the vehicle 10 by controlling the swing angle φ of the swing member 36.

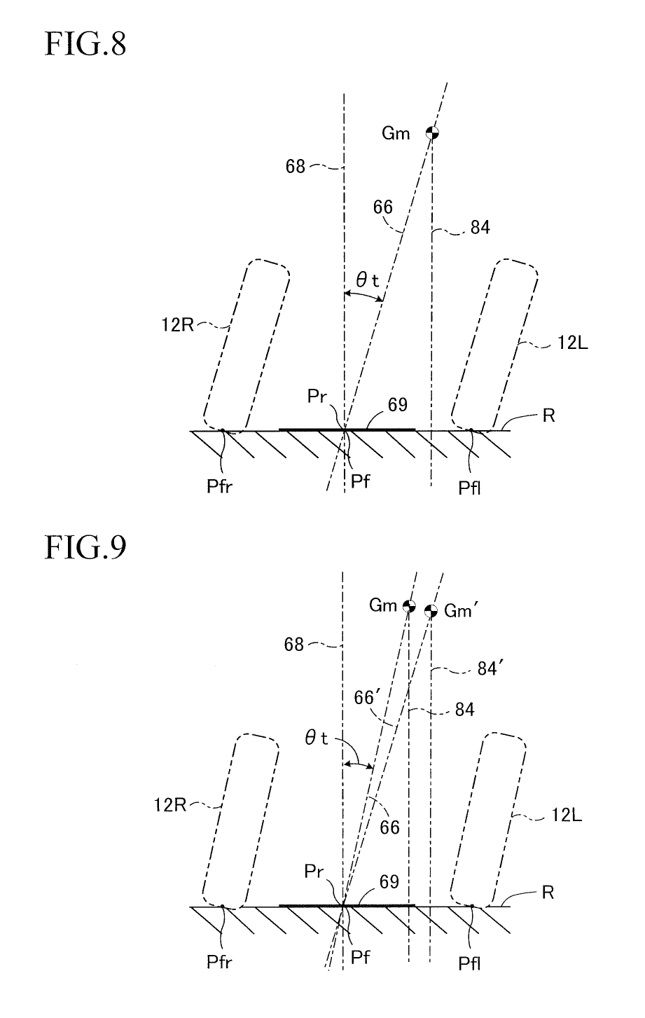

Further, as shown in FIG. 9, the electronic control unit 20 reduces and corrects the target tilt angle θt so that a perpendicular line 84 passing through the center of gravity Gm of the vehicle 10 passes within the range of the triangle 69 (see FIG. 4) when, as shown in FIG. 8, the perpendicular line 84 passes outside the range of the triangle 69. Therefore, the tilt angle of the vehicle when the perpendicular line 84 passes inside an oblique side of the triangle 69 by a distance of a predetermined margin being referred to as the maximum allowable tilt angle θamax, the target tilt angle θt is corrected as necessary so that the magnitude of the target tilt angle does not exceed a maximum allowable tilt angle θamax. Notably, the predetermined margin is preset in consideration of manufacturing tolerances of various members and the like. Further, in FIG. 9, the positions of the center of gravity Gm, the center plane 66 and the perpendicular line 84 shown in FIG. 8 are indicated by reference symbols Gm′, 66′ and 84′, respectively.

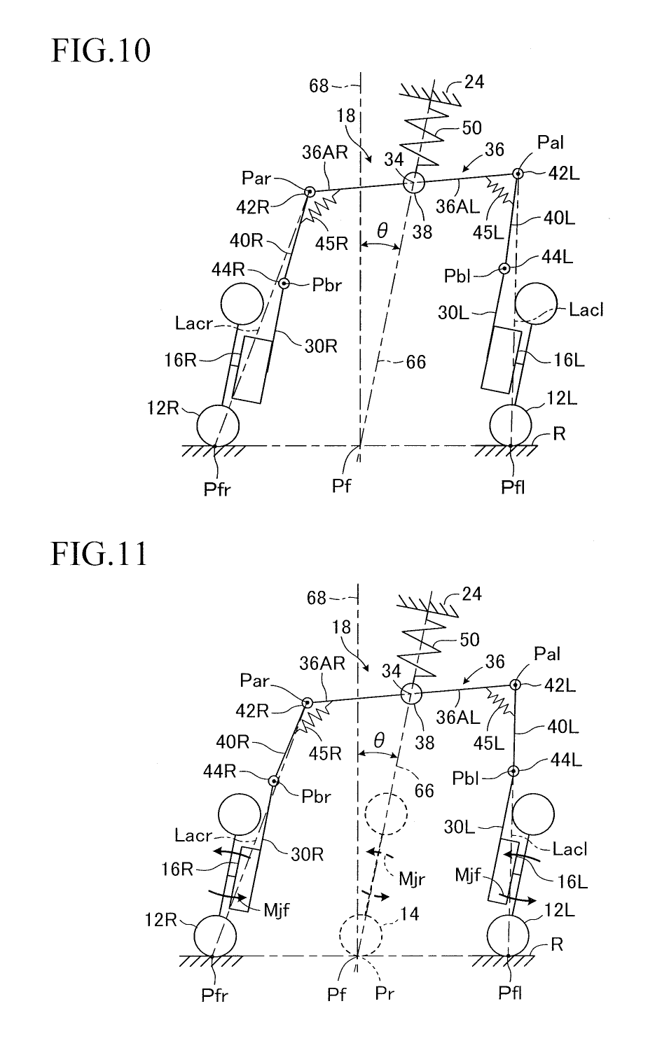

As described above, as the tilt angle θ of the vehicle 10 increases, the pivot point Pbl on the turning outer wheel side moves toward the outside in the lateral direction of the vehicle, and conversely, the pivot point Pbr on the turning inner wheel side moves toward the inside in the lateral direction of the vehicle. The embodiment is configured such that, as shown in FIG. 10, when an absolute value of the tilt angle θ of the vehicle 10 is equal to or less than the absolute value of the maximum allowable tilt angle θamax, the pivot point Pbr is positioned inside the vehicle with respect to the line segment Lacr and the pivot point Pbl is positioned inside the vehicle with respect to the line segment Lacl.

Although the electronic control unit 20 and the sensors such as the gyroscope 70 are shown outside the vehicle 10 in FIG. 1, they are mounted on the vehicle 10. The electronic control unit 20 may be a microcomputer having, for example, a CPU, a ROM, a RAM, and an input/output port device, which are connected to each other by a bi-directional common bus. The control program corresponding to the flowchart shown in FIG. 7 is stored in the ROM, and the tilt angle θ and the like of the vehicle 10 are controlled by the CPU according to the control program.

### <Vehicle Tilt Angle Control Routine>

Next, a tilt angle control routine of the vehicle in the embodiment will be described with reference to the flowchart shown in FIG. 7. The tilt angle control according to the flowchart shown in FIG. 7 is repeatedly executed at predetermined time intervals when an ignition switch (not shown) is on.

First, in step 10, signals such as a signal indicating the tilt angular velocity θd of the vehicle detected by the gyroscope 70 are read.

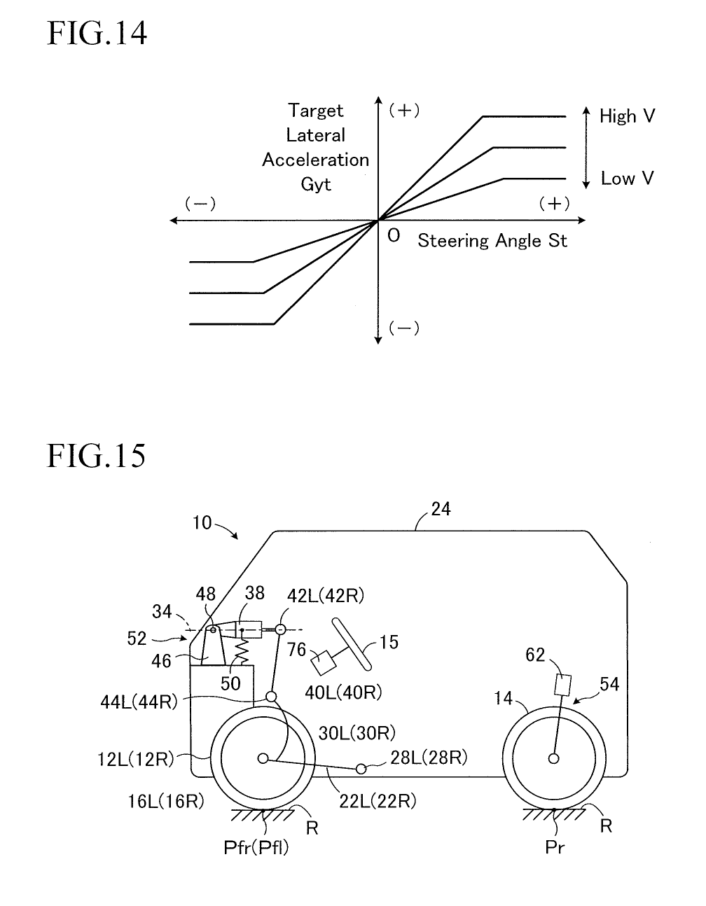

In step 20, the vehicle speed V is calculated on the basis of the wheel speeds ωFL, ωFR and ωR, and a map shown in FIG. 14 is referred to based on a steering angle St and the vehicle speed V, whereby a target lateral acceleration Gyt is calculated. Further, a centrifugal force Fy acting on the center of gravity Gm of the vehicle 10 by turning is calculated as a product of the target lateral acceleration Gyt and a mass M of the vehicle. Incidentally, as shown in FIG. 14, the target lateral acceleration Gyt is calculated such that the larger an absolute value of the steering angle St is, the larger the magnitude is, and the larger the vehicle speed V is, the larger the magnitude is.

In step 30, a target tilt angle θt of the vehicle for tilting the vehicle 10 toward the turning inner side is calculated. In this case, the target tilt angle θt of the vehicle is calculated so that as shown in FIG. 6, a resultant force Fyg of the centrifugal force Fy acting on the center of gravity Gm of the vehicle 10 and the gravity Fg acts on the line connecting a midpoint Pf of the grounding points Pfl and Pfr of the front wheels 12L and 12R and the grounding point Pr of the rear wheel 14.

In step 40, when a magnitude of the target tilt angle θt of the vehicle exceeds the maximum allowable tilt angle θamax, the target tilt angle θt is corrected so that the magnitude becomes the maximum allowable tilt angle θamax. When the magnitude of the target tilt angle θt is equal to or less than the maximum allowable tilt angle θamax, that is, when the perpendicular line 84 passing through the center of gravity Gm of the vehicle 10 passes inside a tolerable margin of the triangle 69 which is not shown in the drawing, the target tilt angle θt of the vehicle is not corrected.

In step 50, a signal indicating the tilt angular velocity θd of the vehicle 10 detected by the gyroscope 70 is read, and a tilt angle θ of the vehicle 10 is calculated by integrating the tilt angular velocity θd. Notably, when the gyroscope 70 outputs a signal indicating the tilt angle θ of the vehicle 10, the integration of a tilt angular velocity θd is unnecessary.

In step 60, it is determined whether or not an absolute value of the deviation θ-θt between the tilt angle θ of the vehicle 10 and the target tilt angle θt of the vehicle is smaller than a reference value θ0 (a positive constant). When the positive determination is made, since the correction of the tilt angle θ of the vehicle is unnecessary, the tilt angle control is temporarily terminated, and when a negative determination is made, the tilt angle control proceeds to step 70.

In step 70, a target swing angle (pt of the swing member 36 for setting the deviation θ-θt between the tilt angle θ of the vehicle 10 and the target tilt angle θt to zero is calculated and a target rotation angle φmt of the electric motor 38M of the tilt actuator 38 for achieving the target swing angle φt is calculated.

In step 80, the electric motor 38M is controlled so that the rotation angle φm of the electric motor 38M becomes the target rotation angle φmt so as to control the swing angle φ of the swing member 36 to the target swing angle φt, whereby the tilt angle θ of the vehicle 10 is controlled so as to be the target tilt angle θt.

As can be understood from the above descriptions, in steps 10 to 30, a target tilt angle θt of the vehicle for tilting the vehicle 10 toward the inside of a turn is calculated. In step 50, a tilt angle θ of the vehicle 10 is calculated based on a tilt angular velocity θd of the vehicle 10 detected by the gyroscope 70. Further, in steps 60 to 80, the electric motor 38M of the tilt actuator 38 is controlled so that a magnitude of a deviation θ-θt between the tilt angle θ of the vehicle 10 and the target tilt angle θt becomes equal to or smaller than the reference value θ0 and a swing angle φ of the swing member 36 reaches a target swing angle φt. Therefore, the vehicle 10 can be turned steadily by tilting the vehicle 10 toward the inside of a turn so that a resultant force Fyg of the centrifugal force Fy acting on the center of gravity Gm of the vehicle 10 and the gravity Fg acts in a predetermined direction.

In step 40, when a perpendicular line 84 passing through the center of gravity Gm of the vehicle 10 passes outside the range of the triangle 69, the target tilt angle θt of the vehicle is corrected so that the perpendicular line 84 passes inside a tolerable margin of the triangle 69. Therefore, even if the vehicle is stopped in a state in which the tilt angle θ of the vehicle is controlled so as to be the target tilt angle θt equal to the maximum allowable tilt angle θamax, it is possible to avoid the vehicle from falling over.

### <Problem Due to Gyro Moments Acting on Front Wheels>

As described above, in the conventional improved automatic tilting vehicle, there are problems that a consumption energy of the tilt actuator 38 is large due to an influence of gyro moments acting on the left and right front wheels 12L and 12R and the controllability of the tilt angle θ of the vehicle is not good. These problems will be described with reference to FIG. 11.

FIG. 11 is a skeleton diagram showing a state in which a conventional automatic tilting vehicle is tilted. Since the tilt actuator 38 is supported so as to pivot about the pivot shafts 48, when the swing member 36 is displaced downward and the rear portion of the actuator 38 is lowered, the front portion of the actuator 38 is raised and the suspension spring 50 expands. In FIGS. 2, 10, and 11, the suspension spring 50 is shown on the upper side of the actuator 38 so that the vertical displacement of the swing member 36 corresponds to the expansion and contraction deformation of the suspension spring 50.

In the conventional improved automatic tilting vehicle, when a magnitude of the tilt angle θ of the vehicle 10 is a large value such as the maximum allowable tilt angle θamax, the pivot point Pbr on the turning outer wheel side is located laterally outwardly of the line segment Lacr connecting the pivot point Par and the grounding point Pfr. The pivot point Pbl on the turning inner wheel side is located on or laterally inside the line segment Lacl connecting the pivot point Pal and the grounding point Pfl.

For example, when the vehicle 10 turns to the left, the swing member 36 is swung in the counterclockwise direction about the swing axis 34 as viewed from the front of the vehicle by a rotational torque of the actuator 38 so that the side of the turning outer wheel becomes lower. As a result, the tie rod 40R on the turning outer wheel side is pushed downwardly with respect to the vehicle body 24, and the tie rod 40L on the turning inner wheel side is lifted upward with respect to the vehicle body 24, resulting in that the entire vehicle 10 is tilted toward the inside of a turn. Therefore, the front wheels 12L and 12R and the rear wheel 14 are inclined toward the inside of the turn by substantially the same angle as the vehicle body 24.

When the front wheels 12L and 12R and the rear wheel 14 are inclined, gyro moments Mjf and Mjr act on the front wheels and the rear wheel, respectively, and the front wheels and the rear wheel tend to return to the positions in the standard state of the vehicle 10. Since the front wheels 12L and 12R each incorporate an in-wheel motor and the mass of each front wheel is larger than the mass of the rear wheel 14, the gyro moments Mjf are larger than the gyro moment Mjr.

Since the front wheels and the rear wheel are in contact with a road surface R at grounding points, and, accordingly, they cannot be displaced in the lateral direction with respect to the road surface, the front wheels 12L and 12R attempt to pivot counterclockwise around the grounding points Pfl and Pfr, respectively. As a result, the rear wheel 14 tries to pivot counterclockwise around the grounding point Pr. Accordingly, since the pivot points Pbl and Pbr attempt to rotate in the counterclockwise direction around the grounding points Pfl and Pfr, respectively, the pivot points Pal and Par are subjected to leftward and downward forces via the tie rods 40L and 40R, respectively. Therefore, the actuator 38 receives a leftward and downward force from the swing member 36, and the force acts to reduce the tilt angle θ of the vehicle 10.

Further, the gyro moments Mjf are transmitted to the vehicle body 24 via the suspension arms 22L and 22R, and the gyro moment Mjr is transmitted to the vehicle body 24 via the rear wheel suspension. Since these gyro moments tend to reduce the inclination of the vehicle body 24, they act to reduce the tilt angle θ of the vehicle 10. Therefore, the actuator 38 must not only swing the swing member 36 so that the tilt angle θ of the vehicle 10 becomes the target tilt angle θt, but also generate a force to maintain the tilt angle θ at the target tilt angle θt against the above action by the gyro moments Mjf and Mjr. Therefore, an energy consumed by the actuator 38 is larger than in the case where the gyro moments Mjf and Mjr do not act on the left and right front wheels 12L and 12R and the rear wheel 14.

Also, when the pivot points Pal and Par are subjected to leftward and downward forces via the tie rods 40L and 40R, the swinging member 36 is displaced downward along the center plane 66 with respect to the vehicle body 24, so that the actuator 38 is also displaced downward, and a height of the vehicle body 24 is lowered. In addition, since a rotational speed of the front wheel 12R as the turning outer wheel is higher than a rotational speed of the front wheel 12L as the turning inner wheel, a magnitude of the gyro moment acting on the front wheel 12R is larger than the magnitude of the gyro moment acting on the front wheel 12L. Accordingly, since the gyro moments acting on the front wheels 12L and 12R act to increase the distance between the pivot points Pbl and Pbr, the quadrilateral Pal-Pbl-Pbr-Par increases its base so that a height of the upper side Pal-Par decreases. Therefore, also by this action, the swing member 36 is displaced downward along the center plane 66 with respect to the vehicle body 24, and the height of the vehicle body 24 is lowered.

When the height of the vehicle body is lowered, the center of gravity Gm of the vehicle 10 is displaced downward along the center plane 66 and the turning radius of the center of gravity increases in comparison with the value in the standard state of the vehicle, resulting in that an actual lateral acceleration Gy decreases. Therefore, since a deviation between the target lateral acceleration Gyt and the actual lateral acceleration Gy of the vehicle becomes large, even if the vehicle tilting device 18 is controlled so that the tilt angle θ of the vehicle 10 becomes a target tilt angle θt, the tilt angle of the vehicle cannot be accurately controlled to the target tilt angle.

Further, when the pivot points Pal and Par receive leftward and downward forces via the tie rods 40L and 40R, respectively, a positional relationship between the swing member 36 and the tie rods 40L and 40R becomes different from that in the standard state of the vehicle 10. As a result, amounts of elastic deformation of the elastic members 45L and 45R elastically urging the swing member 36, the tie rods 40L and 40R, etc. to the positions in the standard state of the vehicle 10 change from their original values, which accumulate energy.

An energy accumulated by the elastic members 45L and 45R is kept constant unless the turning state of the vehicle 10 changes. On the other hand, when the vehicle is rapidly decelerated and rotational speeds of the front wheels 12L and 12R and the rear wheel 14 rapidly decrease in a situation where the vehicle 10 is turning, the gyro moments Mjf acting on the front wheels 12L and 12R and the gyro moment Mjr acting on the rear wheel 14 also decrease sharply. As a result, the accumulated energy is abruptly released, so that the amounts of deformation of the elastic members 45L and 45R sharply decrease so as to become original values, and the swing member 36 tends to displace upward along the center plane 66 with respect to the vehicle body 24.

Consequently, the vehicle body 24 rapidly displaces upward along the center plane 66, a height of the center of gravity Gm of the vehicle 10 abruptly increases, and a compression deformation amount of the suspension spring 50 abruptly increases. Accordingly, since the elastic deformation amounts of the elastic members 45L and 45R and the suspension spring 50 vibrately increase and decrease, the height of the center of gravity Gm of the vehicle 10 vibrates, and an actual lateral acceleration Gy of the vehicle also vibrates. Therefore, even if the vehicle tilting device 18 is controlled so that the tilt angle θ of the vehicle 10 becomes the target tilt angle θt, the tilt angle θ of the vehicle vibrates and the tilt angle θ of the vehicle cannot accurately be controlled to the target tilt angle θt.

### <Improvement of Controllability of Tilt Angle θ of Vehicle in Embodiment>

As described above, when the tilt angle θ of the vehicle is equal to or less than the maximum allowable tilt angle θamax during the vehicle 10 is turning to the left, the pivot point Pbr is located inside the vehicle with respect to the line segment Lacr, and the pivot point Pbl is located inside the vehicle with respect to the line segment Lacl (See FIG. 10).

Therefore, when the vehicle 10 turns to the left, the right front wheel 12R which is the turning outer wheel attempts to pivot in the counterclockwise direction around the grounding point Pfr by the gyro moment Mjf acting on the right front wheel, so that the pivot point Pbr attempts to rotate in the counterclockwise direction around the grounding point Pfr. As a result, a length of the line segment Lacr increases and the pivot point Par is displaced upward along the center plane 66.

Conversely, as the left front wheel 12L which is the turning inner wheel attempts to pivot counterclockwise around the grounding point Pfl by the gyro moment Mjf acting on the left front wheel, so that the pivot point Pbl attempts to rotate counterclockwise around the grounding point Pfl. As a result, a length of the line segment Lacl decreases and the pivot point Pal is displaced downward along the center plane 66.

Therefore, a distance between the grounding point Pfr on the turning outer wheel side and the actuator 38 increases, and a distance between the grounding point Pfl on the turning inner wheel side and the actuator 38 decreases, so that an amount of decrease in the tilt angle θ of the vehicle 10 due to the action of the gyro moments Mjf and Mjr is reduced. Accordingly, it is possible to reduce the force that the actuator 38 must generate to maintain the tilt angle θ at the target tilt angle θt against the action of the gyro moments Mjf and Mjr, so that an energy consumed by the actuator 38 can be reduced.

Since a rotational speed of the right front wheel 12R which is the turning outer wheel is higher than a rotational speed of the left front wheel 12L which is the turning inner wheel, a magnitude of the gyro moment acting on the right front wheel 12R is larger than a magnitude of the gyro moment acting on the left front wheel 12L. Therefore, since an upward displacement amount of the pivot point Par is larger than a downward displacement amount of the pivot point Pal, an amount of downward displacement of the rear portion of the swing member 36 and the actuator 38 can be reduced as compared with the conventional improved automatic tilting vehicle.

In view of the cases where the tilt angle θ of the vehicle 10 at the time of left turning is the same, an angle formed by the straight line connecting the pivot point Pbr on the turning outer wheel side and the grounding point Pfr with the road surface R in the embodiment is smaller than an angle formed by the straight line with the road surface R in the conventional improved automatic tilting vehicle. Accordingly, in view of the cases where magnitudes of the gyro moments Mjf are the same, an amount of movement of the pivot point Pbr toward the outside of a turn due to the pivotal movement of the right front wheel 12R around the grounding point Pfr is smaller than that in the conventional improved automatic tilting vehicle. Therefore, the amounts by which the bottom side of the quadrangle Pal-Pbl-Pbr-Par is increased and the height of the upper side Pal-Par is reduced by the action of the gyro moments on the front wheels 12L and 12R can also be decreased than in the conventional improved automatic tilting vehicle.

Consequently, it is possible to reduce an amount of displacement of the center of gravity Gm of the vehicle 10 downward along the center plane 66, and to reduce an amount by which the turning radius of the center of gravity increases compared with those in the standard state of the vehicle, which enables to reduce an amount by which the actual lateral acceleration Gy decreases. Therefore, since a deviation between the target lateral acceleration Gyt and the actual lateral acceleration Gy of the vehicle can be reduced, the tilt angle θ of the vehicle 10 can be accurately controlled to a target tilt angle θt as compared with the prior art, and the controllability of the tilt angle can be improved.

Further, an amount by which the swing member 36 is displaced downward along the center plane 66 with respect to the vehicle body 24 can be reduced, which enables to reduce an amount by which the height of the vehicle body 24 decreases and to reduce a degree of differentiation of the positional relationship between the swing member 36 and the tie rods 40L and 40R from their relationship in the standard state of the vehicle. Therefore, as compared with the prior art, it is possible to reduce an energy amount accumulated by means of that elastic deformation amounts of the elastic members 45L and 45R elastically urging the swing member 36 and the tie rods 40L and 40R and the like to the positions in the standard state of the vehicle 10 become different from the original values.

Consequently, even if the vehicle is decelerated suddenly, an amount of energy released when rotational speeds of the front wheels abruptly decrease can be reduced. Therefore, a vibration of a height of the center of gravity Gm of the vehicle 10 caused by vibrationally increasing or decreasing amounts of elastic deformations of the elastic members 45L and 45R and the suspension spring 50 can be reduced, and a vibration of an actual lateral acceleration Gy of the vehicle can be reduced. Therefore, the vibration of the tilt angle θ of the vehicle can be reduced, which also enables to improve the controllability of the tilt angle θ of the vehicle.

Although not shown in the drawing, even when the vehicle 10 turns to the right, except that the inner and outer turning wheels are opposite to those at the time of left turn of the vehicle, energy consumption by the actuator 38 can be reduced by the same action and the controllability of the tilt angle θ of the vehicle can be improved.

In particular, according to the embodiment, the vehicle tilting device 18 includes a pair of knuckle arms 30L and 30R extending at least in the upward direction with respect to the knuckles 16L and 16R, respectively and vertically moving integrally with the corresponding knuckles. The tie rods 40L and 40R are pivotally attached to the upper ends of the corresponding knuckle arms 30L and 30R by joints 44L and 44R, respectively which are pivotal attachment portions at the lower ends.

Consequently, heights of the joints 44L and 44R at the lower ends of the tie rods 40L and 40R can be increased, as compared with the conventional improved automatic tilting vehicle in which the vehicle tilting device does not include a pair of knuckle arms. As a result, it is possible to increase the distances between the grounding points Pfl and Pfr of the wheels and the pivot points Pbl and Pbr, respectively. Therefore, when each wheel attempts to pivot about the grounding point by the action of the gyro moment to reduce the tilt angle, a height of the pivot point at the lower end of the tie rod on the outer side of a turn can effectively be increased, and an amount of downward displacement of the rear portion of the actuator 38 with respect to the vehicle body 24 when the vehicle turns can effectively be reduced.

Further, according to the embodiment, a reduction rate of the distance between the pivot point of the upper end and the pivot point of the lower end is 3% or less, preferably 2% or less, more preferably 1% so as to prevent the knuckle arms 30L, 30R and the tie rods 40L, 40R from being substantially curvingly deformed even when compression loads change due to the operation of the vehicle tilting device 18.

Therefore, it is possible to substantially prevent the rear portion of the actuator 38 from being displaced downward relative to the vehicle body 24 that may be caused by a the fact that the knuckle arm and/or the tie rod on the turning outer wheel side is curvingly deformed due to the change in the compressive load and the distance between the pivot point of the upper end and the pivot point of the lower end is reduced at the time of turning of the vehicle. In addition, it is possible to prevent occurrence of a curved deformation of the knuckle arm and/or the tie rod which reduces the effect of displacing the pivotal attachment portion at the upper end of the tie rod upward that can be obtained by the pivotal attachment portion at the lower end of the tie rod on the turning outer wheel side rotating to the turning outside around the grounding point of the corresponding front wheel.

Furthermore, according to the embodiment, a camber of the front wheels 12L and 12R is a neutral camber. Therefore, even when a loading load of the vehicle 10 is high, it is possible to reduce the possibility that the camber angle of the front wheels 12L and 12R becomes an excessive angle of a negative camber and to reduce the possibility that a laterally inner portion of a tire of the turning outer wheel will be abnormally worn.

### [Modification]

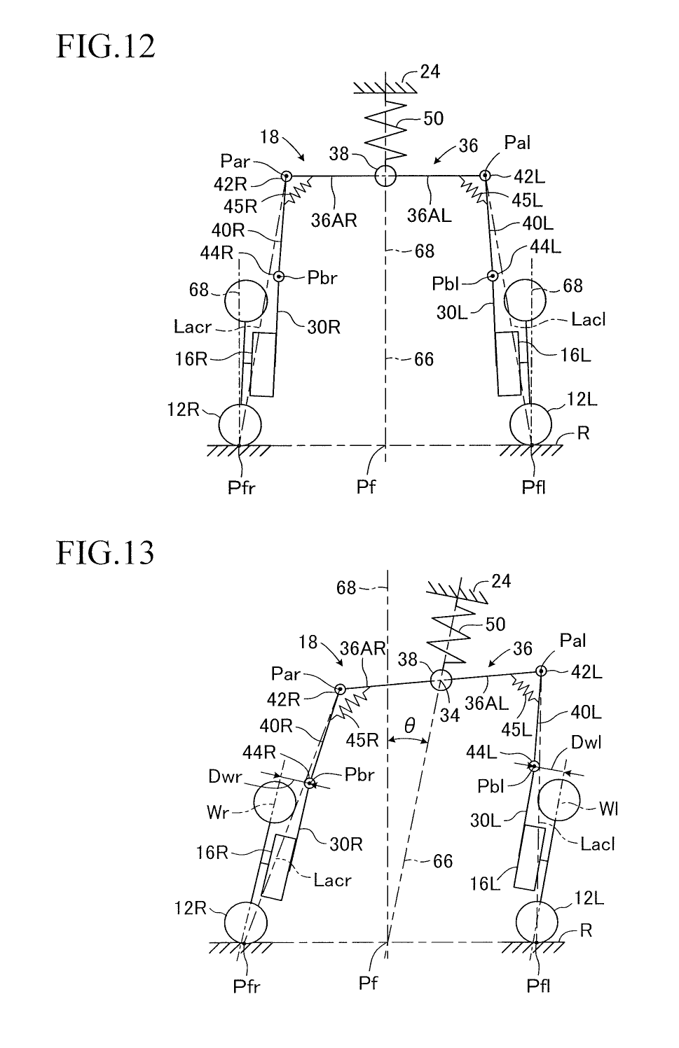

In a modification shown in FIGS. 12 and 13, the front wheels 12L and 12R have negative cambers when the vehicle 10 is in the standard state. Therefore, as understood from the comparison between FIG. 13 and FIG. 10, an inclination angle of the front wheel 12R on the outside of a turn with respect to the vertical direction 68 when the vehicle 10 is tilted to the inside of the turn is larger than that in the embodiment and conversely an inclination angle of the front wheel 12L on the turning inner wheel side is smaller than that in the embodiment.

According to the modification, it is possible to reduce distances Dwl, Dwr between rotation center planes Wl, Wr of the front wheels 12L, 12R and the pivot points Pbl, Pbr at the lower ends of the tie rods as compared to where the camber of each front wheel is a neutral camber or a positive camber can be reduced. Accordingly, it is possible to easily arrange the pivot points Pbl and Pbr on the outside of a turn with respect to the line segments Lacl and Lacr on the inner side of the vehicle while avoiding that the distances Dwl, Dwr become excessive and avoiding lowering of an efficiency with which the swing member 36 moves the front wheels up and down relative to the vehicle body 24 via the tie rods 40L and 40R.

Although the present disclosure has been described in detail with reference to the specific embodiment and modification, it will be apparent to those skilled in the art that the present disclosure is not limited to the above-described embodiment and modification, and various other embodiments are possible within the scope of the present disclosure.

For example, in the above-described embodiment, the actuator 38 is supported so as to be swingable about a pair of pivot shafts 48 by supporting the pivot shafts 48 provided at the center portion in the longitudinal direction thereof by the pair of brackets 46. The output rotary shaft of the actuator 38 protrudes rearward and the boss portion 36B of the swing member 36 is integrally attached to the tip of the output rotary shaft, and the suspension spring 50 and the shock absorber are connected to the front end of the actuator 38 and the vehicle body 24 below the front end.

However, as shown in FIG. 15, the pivot shafts 48 may be provided at the front end of the actuator 38, the suspension spring 50 and the shock absorber may be interposed between the actuator 38 and the vehicle body 24 on the rear side with respect to the pivot shafts 48 (a first modified embodiment). In that case, since a weight of the vehicle body 24 is supported by a spring force due to an elongation deformation of the suspension spring 50, the suspension spring may be an elastic member such as a tension coil spring, for example. When the rear portion of the actuator 38 is moved downward with respect to the vehicle body 24 due to the gyro moments acting on the front wheels, a height of the vehicle body 24 is reduced due to a reduction in an amount of extension deformation of the suspension spring 50.

Further, the positional relationship of the swing member 36, the suspension spring 50, and the shock absorber in the longitudinal direction with respect to the pivot shafts 48 of the actuator 38 may be opposite to the relationship in the above embodiment. That is, the actuator 38 may be disposed behind the vehicle tilting device 18, the boss portion 36B of the swing member 36 may be integrally attached to the output rotary shaft that projects forward, and the suspension spring 50 and the shock absorber may be interposed between the rear end of the actuator 38 and the vehicle body 24. Furthermore, the positional relationship of the swing member 36, the suspension spring 50 and the shock absorber in the longitudinal direction with respect to the pivot shafts 48 of the actuator 38 may be opposite to the relationship in the above-described first modified embodiment.

Further, the actuator 38 may be supported by the vehicle body so as to move up and down with respect to the vehicle body 24 without oscillating (a second modified embodiment). In that case, a suspension spring 50 such as a compression coil spring may be interposed between the actuator 38 and the vehicle body member above the actuator, or a suspension spring 50 such as a tension coil spring may be interposed between the actuator 38 and the vehicle body member below the actuator.

In the above-described embodiment, the effective lengths of the tie rods 40L and 40R, that is, the distances between the pivot points Par and Pal and the pivot points Pbr and Pbl, respectively are smaller than the distances between the pivot points Pbr and Pbl and the grounding points Pfr and Pfl, respectively. However, the effective lengths of the tie rods 40L and 40R may be greater than the distances between the pivot points Pbr and Pbl and the grounding points Pfr and Pfl, respectively. The relationships between the effective lengths of the tie rods 40L and 40R and the distances between the pivot points Pbr and Pbl and the grounding points Pfr and Pfl with respect to the effective lengths of the arm portions 36AL and 36AR may be different from the illustrated relationships.

Further, in the above-described embodiment, the arm portions 36AL and 36AR of the swing member 36 are formed in a straight line without being inclined to each other and extend horizontally when the vehicle 10 is in the standard state. However, the arm portions 36AL and 36AR may be V-shaped so that their heights increase as the distances from the boss portion 36B increase or conversely, may have an inverted V shape so that the height decreases as the distances from the boss portion 36B increase.

Further, in the above embodiment, the lower ends of the tie rods 40L, 40R are connected to the knuckles 16L, 16R via the knuckle arms 30L, 30R and the suspension arms 22L, 22R, respectively. However, the knuckle arms 30L, 30R may be integrally connected at the lower ends to the knuckles 16L, 16R, respectively. Furthermore, the knuckle arms 30L, 30R may be omitted, and the tie rods 40L, 40R may be pivotally attached at the lower ends to the knuckles 16L, 16R, respectively.

1. An automatic tilting vehicle which includes a pair of laterally spaced wheels, a vehicle tilting device, and a control unit; each wheel is rotatably supported by a corresponding knuckle; the vehicle tilting device includes a swing member swinging around a swing axis extending in the longitudinal direction of the vehicle, an actuator for swinging the swing member around the swing axis, and a pair of tie rods pivotally attached to the swing member at upper end pivotal attachment portions on both lateral sides of the swing axis and pivotally attached to corresponding knuckles at lower end pivotal attachment portions; the control unit is configured to calculate a target tilt angle of the vehicle so as not to exceed a preset allowable maximum tilt angle at the time of turning of the vehicle and to tilt the vehicle to the inner side of a turn by controlling the actuator so that the tilt angle of the vehicle conforms to the target tilt angle, wherein
the actuator is connected to the vehicle body via a suspension spring so as to be vertically displaceable with respect to the vehicle body and to limit the lateral displacement and inclination with respect to the vehicle body;
the pair of wheels, the actuator, the swinging member and the pair of tie rods are resiliently biased to the positions that they take when the vehicle runs straight; and
the vehicle tilting device is arranged such that, when the tilt angle of the vehicle is equal to or less than the allowable maximum tilt angle, as viewed in the longitudinal direction of the vehicle, a pivot point of the pivotal attachment portion at the lower end of the tie rod on the outer side of a turn is located on the inside of the vehicle with respect to a line segment connecting a grounding point of the corresponding wheel and a pivot point of the pivotal attachment portion of the upper end of the tie rod.

2. The automatic tilting vehicle according to claim 1, wherein the vehicle tilting device includes a pair of knuckle arms extending at least in the upward direction with respect to the respective knuckles and vertically moving integrally with the corresponding knuckles, and each tie rod is pivotally attached to the upper end of the corresponding knuckle arm at the lower end pivotal attachment portion.

3. The automatic tilting vehicle according to claim 1, wherein a camber of the pair of wheels is a negative camber.

4. The automatic tilting vehicle according to claim 1, wherein the pair of tie rods are configured not to be substantially curvingly deformed even if compressive loads vary due to the operation of the vehicle tilting device.

5. The automatic tilting vehicle according to claim 2, wherein the pair of tie rods are configured not to be substantially curvingly deformed even if compressive loads vary due to the operation of the vehicle tilting device.

6. The automatic tilting vehicle according to claim 3, wherein the pair of tie rods are configured not to be substantially curvingly deformed even if compressive loads vary due to the operation of the vehicle tilting device.
